(19) United States
(12) Patent Application Publication
(10) Pub. No.: US 2004/0093737 A1
(43) Pub. Date: May 20, 2004

(54) Fruit coring device for producing a closed bore

(76) Inventor: George Mauro, Salem, NH (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/294,246

(22) Filed: Nov. 14, 2002

(51) Int. Cl. A47J 25/00

(52) U.S. Cl. 30/113.1; 30/113.3

(57) ABSTRACT

A fruit coring device comprising a right circular tubular member having an interior defining a longitudinal axis and having first and second ends, the first end being fast with a handle and the second end defining a circular cutting edge, and a flat blade having a length disposed diametrically transverse of the member, a width extending along the axis, from a straight cutting edge, of the flat blade, disposed adjacent the circular cutting edge, and extending normal to the axis, diametrically across the interior of the member.

### FIELD OF THE INVENTION

The invention relates to a device for removing the core of a fruit, particularly though not exclusively, an apple, to leave a closed ended bore (blind hole) to facilitate retention of a filling during baking to produce a baked fruit, e.g. an apple.

### BACKGROUND OF THE INVENTION

Typical coring devices for apples are designed to remove the apple core by removing a plug, including the core, from a bore which extends completely through the apple. An example of such a device is illustrated in FIG. 1. This prior art device comprises a part circular elongate blade 1 having serrated edges 2 extending for much of the length of the blade from a handle 3 to a pointed blade end 4.

The pointed end 4 is inserted, usually from the stalk end of the apple, and the device is them rotated about a longitudinal axis defined by the blade while the blade 1 is pushed into the apple so that the teeth of the serrated edges 2 cut or tear the apple about its core until the blade 1 projects from the end of the apple opposite the stalk. The device is then removed, often leaving the core plug containing the core in place for separate removal, thereby adding a separate step in the removal of the core and leaving a bore open at both ends which hinders or prevents the retention of a filling during a baking operation.

In another prior art arrangement a circular tube, having a serrated circular edge extends away from a handle to which it is connected by a part circular member. This prior art device has similar drawbacks to those described with reference to FIG. 1.

### OBJECT OF THE INVENTION

It is an object of the present invention to provide an improved coring device suitable for use in easily removing the core of an apple in one step while providing a closed ended bore to provide for retention of a filling in the bore during baking to produce a baked apple.

It is also an object of the present invention to provide such a coring device for apples which is economical and easy to manufacture while having a long life expectancy and great durability and reliability.

### SUMMARY OF THE INVENTION

The present invention provides a fruit coring device comprising a right circular tubular member having a circular interior defining a longitudinal axis and first and second ends, the first end being fast with a handle and the second end defining a circular cutting edge, and a flat blade having a length disposed diametrically transverse of the member, a width extending along the axis, from a straight cutting edge, of the flat blade, disposed adjacent the circular cutting edge and extending normal to the axis, diametrically across the interior of the member.

The circular cutting edge may be defined by at least one taper formed in the member, preferably converging tapers formed in the member with each taper having an angle of about 150 of the axis.

The circular cutting edge may be serrated.

The handle preferably has two opposed extensions extending away from the axis.

### BRIEF DESCRIPTION OF THE DRAWINGS

The invention will now be described, by way of example, with reference to the accompanying drawings, in which:

FIG. 1 illustrates a prior art apple corer;

FIG. 2 is perspective view of the apple coring device of the present invention;

FIG. 3 is a fragmentary cross-section taken on line 3-3 of FIG. 2;

FIG. 4 is a cross-section taken on line 4-4 if FIG. 2;

FIG. 5 is a fragmentary view of the handle portion of FIG. 2 with an optional ring to limit penetration of the device into an apple being cored; and

FIG. 6 is a fragmentary view of an alternative cutting edge to that of FIG. 1.

### DESCRIPTION OF PREFERRED EMBODIMENTS

Referring first to FIG. 2, an apple coring device 5 comprises a right circular tubular member 6 extending from one end 7, attached a handle 8, to an opposite end 9 which forms a circular cutting edge 10 traversed by a straight blade 11 attached within the tubular member 6.

The handle 8 may be integral with end 7 or is fast with the end 7 by the use of e.g. a press fit, adhesive, rivets, welding, etc. and defines a pair of opposed projections 12, each having a finger engaging opener 13.

The length of the tubular member 6 from the cutting edge 10 to the proximate surface of the handle 8 is about 1.7 inches and the inside diameter of the tubular member 6 is about 0.9 inches.

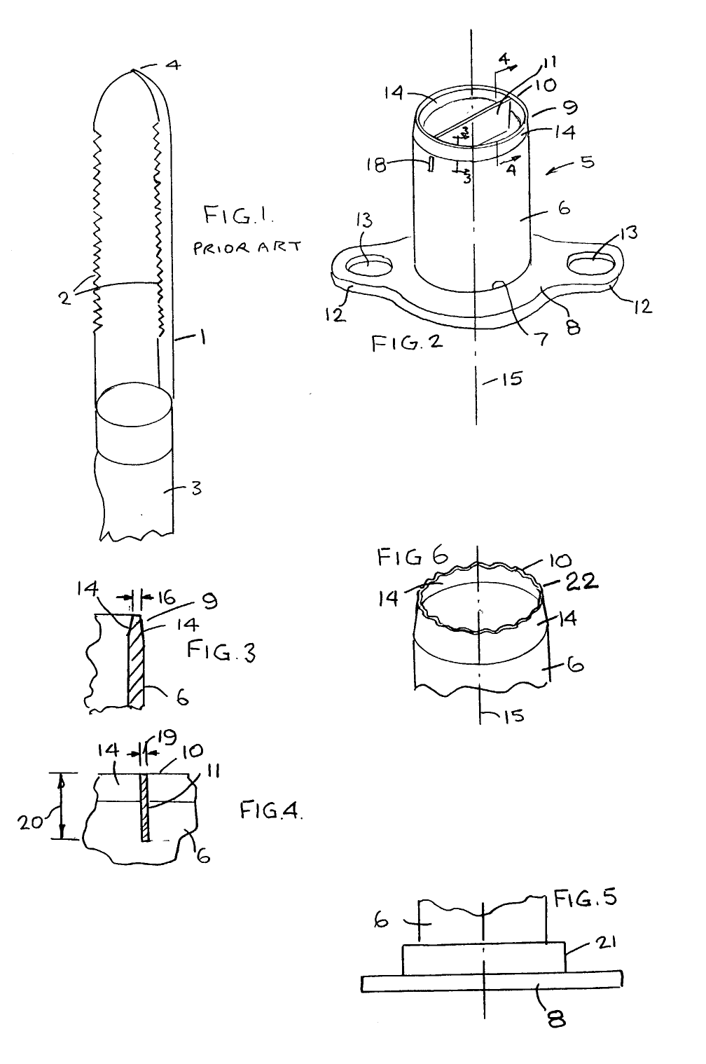

As best seen in FIGS. 1 and 3, the cutting edge 10 of the tubular member 6 is formed by tapers 14, respectively on the inside and outside of the tubular member 6, each having an angle of about 150 relative to the longitudinal axis 15 to reduce the wall thickness of the tubular member from about 0.030 inches to the cutting edge which having a width 16 of about 0.005 inches.

Extending diametrically across the cutting edge defining end of the tubular member 6 is a straight flat blade 11 having a cutting edge 17 closely adjacent the cutting edge 10 of the tubular member 6. The blade 11 may be firmly supported in slots 18 (one only being shown) located at the ends of the blade 11 or by other means that will be well known to those skilled in the art. The blade 11 extends from its straight cutting edge 17 along the axis toward the handle 8. The straight cutting edge has a thickness 19 (FIG. 4) of about 0.015 inches and the blade 11 has a width 20 extending along the axis 15 of about 0.5 inches.

In order to function to produce a closed ended bore in small apples one or more rings 21 may be provided (FIG. 5) to fit over the tubular member 6 against the handle 8 to reduce the depth of the bore that can be produced by the device 5.

In an alternative embodiment (FIG. 6) the cutting edge 10 of the tubular member may be serrated 22 to aid in the initial penetration of the apple's skin.

To operate the device the cutting edge 10 of the tubular member 6 is pushed, usually from the stalk end of the apple, without twisting, into the apple until the handle contacts the apple. The handle is then used to turn the device 5 including the blade 11 about ¼ of a turn about the axis 15 and then pulled out of the apple taking with it a core plug including the apple core and leaving a closed ended bore in the apple to accept, in leak proof manner, a filling used in the production of baked apple. Following initial penetration the device may be realigned to ensure accurate alignment for removal of the core.

### REFERENCE NUMBERS

1 blade

2 edges

3 handle

4 pointed end

5 apple coring device

6 tubular member

7 one end

8 handle

9 opposite end

10 cutting edge

11 blade

12 projections

13 openings

14 tapers

15 longitudinal axis

16 width

17 cutting edge

18 slots

19 thickness

20 width

21 ring

22 serrated edge

I claim:

1. A fruit coring device comprising a right circular tubular member having a circular interior defining a longitudinal axis and first and second ends, the first end being fast with a handle and the second end defining a circular cutting edge, and a flat blade having a length disposed diametrically transverse of the member, a width extending along the axis, from a straight cutting edge, of the flat blade, disposed adjacent the circular cutting edge and extending normal to the axis, diametrically across the interior of the member.

2. The fruit coring device of claim 1 wherein the circular cutting edge is defined by at least one taper formed in the member.

3. The fruit coring member of claim 2 wherein the circular cutting edge is formed by converging tapers formed in the member.

4. The fruit coring member of claim 3 wherein each taper has an angle of about 150 to the axis.

5. The fruit coring member of claim 1 wherein the circular cutting edge is serrated.

6. The fruit coring member of claim 1 wherein the handle has two opposed extensions extending away from the axis.
